(19) United States
(12) Patent Application Publication
(10) Pub. No.: US 2024/0256945 A1
(43) Pub. Date: Aug. 1, 2024

(54) ERROR DETECTION AND CORRECTION SYSTEMS FOR DATA PROCESSING IMPLEMENTED VIA ARTIFICIAL INTELLIGENCE

(71) Applicant: Evicore Healthcare MSI, LLC, Bluffton, SC (US)

(72) Inventor: Sarita Mantravadi, Pearland, TX (US)

(21) Appl. No.: 18/103,806

(22) Filed: Jan. 31, 2023

(51) Int. Cl. G06N 20/00

(52) U.S. Cl. CPC G06N 20/00

(57) ABSTRACT

A system includes memory hardware configured to store instructions, and processing hardware configured to execute the instructions. The instructions include training a machine learning model by loading a training data set, the training data set including a first bin and a second bin, applying an under-sampling technique to elements of the first bin to generate an updated first bin, applying an over-sampling technique to elements of the second bin to generate an updated second bin, generating an updated training data set by merging the updated first bin and the updated second bin, and training the machine learning model with the updated training data set, and providing the input variables to the trained machine learning model to generate output variables.

### FIELD

The present disclosure relates to error detection and correction for computer systems and, more particularly, to identifying and correcting systematic errors in software for data processing systems implemented using artificial intelligence.

### BACKGROUND

Machine learning technologies use algorithms and statistical models to analyze and draw inferences from patterns present in data sets. Accordingly, machine learning technologies do not require explicit instructions laying out their programming logic and are especially adept at helping organizations parse and make sense of ever larger and ever more diverse data sets. Machine learning technologies have been widely adopted by—and are transforming—many segments of the modern world. However, because machine learning technologies typically rely on a training process to determine suitable parameters for the specific machine learning model, individual machine learning models tend to be accurate only if their training processes are of high quality.

Incomplete or poor-quality training data sets may result in flawed machine learning models that produce inaccurate or unusable results. One example of a poor-quality training data set is one where the important ranges of a user or entity's preferences are poorly represented. For example, the training data set may include few examples of data within these important ranges. Because the accuracy of the results of machine learning models tend to be negatively affected when the models are trained with incomplete or poor-quality training data sets—such as data sets missing data within important ranges—there exists a need for techniques to improve the accuracy machine learning model training even with incomplete or poor-quality training data sets.

Furthermore, the quality of the input variables provided to machine learning models tends to affect the accuracy of the results. For example, some input variables may have a greater effect on the results than others. Given the large size and great diversity of modern data sets, there exists a need for automated techniques to improve the relevance of input variable data sets.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes training a machine learning model by loading a training data set, the training data set including a first bin and a second bin, applying an under-sampling technique to elements of the first bin to generate an updated first bin, applying an over-sampling technique to elements of the second bin to generate an updated second bin, generating an updated training data set by merging the updated first bin and the updated second bin, and training the machine learning model with the updated training data set. The method includes generating input variables by assigning alphanumeric strings to elements of a raw data set, tokenizing each alphanumeric string, converting the tokenized strings to scalar values, performing frequency filtering to emphasize scalar values based on a frequency the scalar values appear in a set of data objects while de-emphasizing scalar values based on a frequency the scalar values appear in a group of sets of data objects, and saving the filtered scalar values as input variables. The method includes providing the input variables to the trained machine learning model to generate output variables.

In other features, the method includes automatically determining optimal hyperparameters for the trained machine learning model and configuring the trained machine learning model with the optimal hyperparameters. In other features, determining the optimal hyperparameters includes loading baseline hyperparameters, configuring the trained machine learning model with the baseline hyperparameters, running the configured machine learning model to determine baseline metrics, and, in response to the baseline metrics being above a threshold, saving the baseline hyperparameters as the optimal hyperparameters. In other features, determining the optimal hyperparameters includes, in response to the baseline metrics being at or below the threshold: adjusting the baseline hyperparameters, reconfiguring the trained machine learning model with the adjusted hyperparameters, running the reconfigured machine learning model to determine updated metrics, and, in response to the updated metrics being more optimal than the baseline metrics, saving the updated metrics as the optimal hyperparameters.

In other features, the method includes, in response to determining the output variables are above a threshold: loading a second trained machine learning model and providing the input variables to the second trained machine learning model to generate second output variables. In other features, the method includes, in response to determining the output variables are not above the threshold: loading a third trained machine learning model and providing the input variables to the third trained machine learning model to generate third output variables. In other features, the trained machine learning model includes a light gradient-boosting machine model. In other features, the trained machine learning model includes a mixed effects random forests model with a light gradient-boosting machine regressor. In other features, input variables include a third bin and a fourth bin. In other features, the input variables of the third bin are assigned to fixed effects and the input variables of the fourth bin are assigned to mixed effects.

A system includes memory hardware configured to store instructions and processing hardware configured to execute the instructions. The instructions include training a machine learning model by loading a training data set, the training data set including a first bin and a second bin, applying an under-sampling technique to elements of the first bin to generate an updated first bin, applying an over-sampling technique to elements of the second bin to generate an updated second bin, generating an updated training data set by merging the updated first bin and the updated second bin, and training the machine learning model with the updated training data set. The instructions include generating input variables by assigning alphanumeric strings to elements of a raw data set, tokenizing each alphanumeric string, converting the tokenized strings to scalar values, performing frequency filtering to emphasize scalar values based on a frequency the scalar values appear in a set of data objects while de-emphasizing scalar values based on a frequency the scalar values appear in a group of sets of data objects, and saving the filtered scalar values as input variables. The instructions include providing the input variables to the trained machine learning model to generate output variables.

In other features, the instructions further comprise automatically determining optimal hyperparameters for the trained machine learning model and configuring the trained machine learning model with the optimal hyperparameters. In other features, determining the optimal hyperparameters includes loading baseline hyperparameters, configuring the trained machine learning model with the baseline hyperparameters, running the configured machine learning model to determine baseline metrics, and, in response to the baseline metrics being above a threshold, saving the baseline hyperparameters as the optimal hyperparameters. In other features, determining the optimal hyperparameters includes, in response to the baseline metrics being at or below the threshold: adjusting the baseline hyperparameters, reconfiguring the trained machine learning model with the adjusted hyperparameters, running the reconfigured machine learning model to determine updated metrics, and, in response to the updated metrics being more optimal than the baseline metrics, saving the updated metrics as the optimal hyperparameters.

In other features, the instructions further comprise, in response to determining the output variables are above a threshold: loading a second trained machine learning model and providing the input variables to the second trained machine learning model to generate second output variables. In other features, the instructions further comprise, in response to determining the output variables are not above the threshold: loading a third trained machine learning model and providing the input variables to the third trained machine learning model to generate third output variables. In other features, the trained machine learning model includes a light gradient-boosting machine model. In other features, the trained machine learning model includes a mixed effects random forests model with a light gradient-boosting machine regressor. In other features, input variables include a third bin and a fourth bin. In other features, the input variables of the third bin are assigned to fixed effects and the input variables of the fourth bin are assigned to mixed effects.

A system includes memory hardware configured to store instructions and processor hardware configured to execute the instructions. The instructions include loading a machine learning model, loading a training data set, loading baseline hyperparameters, configuring the machine learning model with the baseline hyperparameters, providing the training data set as inputs to the machine learning model configured with the baseline hyperparameters to determine baseline performance metrics, determining whether the baseline performance metrics are above a threshold, saving the baseline hyperparameters as optimal hyperparameters in response to determining that the baseline performance metrics are above the threshold, configuring the machine learning model with the optimal hyperparameters, loading input variables, providing the input variables as inputs to the machine learning model configured with the optimal hyperparameters to generate output variables, saving the output variables to a database, and generating a graphical user interface. The graphical user interface is configured to access the output variables from the database and display the output variables to a user.

In other features, the input variables include an identifier of an entity in a population, the output variables include a score for the entity indicated by the identifier, and the score indicates a likelihood of a feature of merit exceeding a threshold. In other features, the instructions include generating a plurality of scores for a plurality of entities in the population and clustering the plurality of scores into a plurality of clusters. In other features, the plurality of clusters is three clusters. In other features, the plurality of clusters includes a particular cluster associated with a greatest risk and the instructions include adapting the graphical user interface in response to the score being assigned to the particular cluster. In other features, the score is a value between zero and one hundred inclusive. In other features, the population includes entities that consume services and the feature of merit is a measure of service consumption of the entity. In other features, the population includes entities that coordinate services and the feature of merit is an amount of services advised by the entity.

In other features, the instructions include, in response to determining that the baseline metrics are not above the threshold, adjusting the baseline hyperparameters. In other features, the instructions include configuring the machine learning model with the adjusted hyperparameters. In other features, the instructions include providing the training data set as inputs to the machine learning model configured with the adjusted hyperparameters to determine updated performance metrics. In other features, the instructions include determining whether the updated performance metrics are more optimal than the baseline performance metrics. In other features, the instructions include, in response to determining that the updated performance metrics are more optimal than the baseline performance metrics, saving the adjusted hyperparameters as the baseline hyperparameters.

In other features, the machine learning model is a light gradient-boosting machine (LightGBM) regressor model. In other features, the output variables include at least one of (i) a per-patient risk score indicating a risk of a patient having a high-risk episode or a high-cost treatment, (ii) a patient identifier, (iii) a physician identifier, (iv) a physician state, and (v) a patient state. In other features, the input variables are stored on one or more storage devices. In other features, the processor hardware is configured to access the one or more storage devices via one or more networks.

A computer-implemented method includes loading a machine learning model, loading a training data set, loading baseline hyperparameters, configuring the machine learning model with the baseline hyperparameters, providing the training data set as inputs to the machine learning model configured with the baseline hyperparameters to determine baseline performance metrics, determining whether the baseline performance metrics are above a threshold, saving the baseline hyperparameters as optimal hyperparameters in response to determining that the baseline performance metrics are above the threshold, configuring the machine learning model with the optimal hyperparameters, loading input variables, providing the input variables as inputs to the machine learning model configured with the optimal hyperparameters to generate output variables, saving the output variables to a database, and generating a graphical user interface. The graphical user interface is configured to access the output variables from the database and display the output variables to a user.

In other features, the method includes adjusting the baseline hyperparameters in response to determining that the baseline metrics are not above the threshold. In other features, the method includes configuring the machine learning model with the adjusted hyperparameters. In other features, the method includes providing the training data set as inputs to the machine learning model configured with the adjusted hyperparameters to determine updated performance metrics. In other features, the method includes determining whether the updated performance metrics are more optimal than the baseline performance metrics. In other features, the method includes saving the adjusted hyperparameters as the baseline hyperparameters in response to determining that the updated performance metrics are more optimal than the baseline performance metrics. In other features, the machine learning model is a light gradient-boosting machine (LightGBM) regressor model or a LightGBM classifier model. In other features, the output variables include (i) per-provider risk scores and (ii) clusters for the per-provider risk scores, and each cluster indicates a risk category.

A computer-implemented method includes loading a training data set. The training data set includes a first bin and a second bin. The method includes applying an under-sampling technique to elements of the first bin to generate an updated first bin, applying an over-sampling technique to elements of the second bin to generate an updated second bin, generating an updated training data set by merging the updated first bin and the updated second bin, loading baseline hyperparameters, configuring a machine learning model with the baseline hyperparameters, providing the updated training data set as inputs to the machine learning model configured with the baseline hyperparameters to determine baseline performance metrics, determining whether the baseline performance metrics are above a threshold, saving the baseline hyperparameters as optimal hyperparameters in response to determining that the baseline performance metrics are above the threshold, configuring the machine learning model with optimal hyperparameters, and providing input variables to the machine learning model configured with the optimal hyperparameters to generate output variables.

In other features, the input variables include an identifier of an entity in a population, the output variables include a score for the entity indicated by the identifier and the score indicates a likelihood of a feature of merit exceeding a threshold. In other features, the score is a value between zero and one hundred inclusive. In other features, the population includes entities that consume services and the feature of merit is a measure of service consumption. In other features, the population includes entities that coordinate services and the feature of merit is an amount of services. In other features, the method includes adjusting the baseline hyperparameters in response to determining that the baseline metrics are not above the threshold. In other features, the method includes configuring the machine learning model with the adjusted hyperparameters. In other features, the method includes providing the training data set as inputs to the machine learning model configured with the adjusted hyperparameters to determine updated performance metrics.

In other features, the method includes determining whether the updated performance metrics are more optimal than the baseline performance metrics. In other features, the method includes saving the adjusted hyperparameters as the baseline hyperparameters in response to determining that the updated performance metrics are more optimal than the baseline performance metrics. In other features, the machine learning model is a light gradient-boosting machine (LightGBM) regressor model. In other features, the output variables include at least one of (i) total drug costs for a months, (ii) member months for health insurance organizations, and (iii) total medical costs for the member, the output variables are stored in one or more databases, and the one or more databases feed into visualization software. In other features, the input variables are stored on one or more storage devices. In other features, the machine learning model is configured to access the input variables via one or more networks.

A system includes memory hardware configured to store instructions and processing hardware configured to execute the instructions. The instructions include loading a training data set. The training data set includes a first bin and a second bin. The instructions include applying an under-sampling technique to elements of the first bin to generate an updated first bin, applying an over-sampling technique to elements of the second bin to generate an updated second bin, generating an updated training data set by merging the updated first bin and the updated second bin, loading baseline hyperparameters, configuring a machine learning model with the baseline hyperparameters, providing the updated training data set as inputs to the machine learning model configured with the baseline hyperparameters to determine baseline performance metrics, determining whether the baseline performance metrics are above a threshold, saving the baseline hyperparameters as optimal hyperparameters in response to determining that the baseline performance metrics are above the threshold, configuring the machine learning model with optimal hyperparameters, and providing input variables to the machine learning model configured with the optimal hyperparameters to generate output variables.

In other features, the instructions include adjusting the baseline hyperparameters in response to determining that the baseline metrics are not above the threshold. In other features, the instructions include configuring the machine learning model with the adjusted hyperparameters. In other features, the instructions include providing the training data set as inputs to the machine learning model configured with the adjusted hyperparameters to determine updated performance metrics. In other features, the instructions include determining whether the updated performance metrics are more optimal than the baseline performance metrics. In other features, the instructions include saving the adjusted hyperparameters as the baseline hyperparameters in response to determining that the updated performance metrics are more optimal than the baseline performance metrics.

In other features, the machine learning model is a light gradient-boosting machine (LightGBM) regressor model. In other features, the output variables include prospective cost estimates for treatments at points of authorization, the output variables are fed into a database, and the database is accessible from a user interface generated by a user interface module. In other features, the input variables are stored on one or more storage devices. In other features, the processing hardware is configured to access the input variables via one or more networks.

A non-transitory computer-readable medium includes executable instructions for training and optimizing machine learning models. The executable instructions include loading a training data set. The training data set includes a first bin and a second bin. The instructions include applying an under-sampling technique to elements of the first bin to generate an updated first bin, applying an over-sampling technique to elements of the second bin to generate an updated second bin, generating an updated training data set by merging the updated first bin and the updated second bin, loading baseline hyperparameters, configuring a machine learning model with the baseline hyperparameters, providing the updated training data set as inputs to the machine learning model configured with the baseline hyperparameters to determine baseline performance metrics, determining whether the baseline performance metrics are above a threshold, saving the baseline hyperparameters as optimal hyperparameters in response to determining that the baseline performance metrics are above the threshold, configuring the machine learning model with optimal hyperparameters, and providing input variables to the machine learning model configured with the optimal hyperparameters to generate output variables.

In other features, the input variables include non-standard identifiers of conditions. In other features, the output variables include standard identifiers of the conditions. In other features, the instructions include adjusting the baseline hyperparameters in response to determining that the baseline metrics are not above the threshold. In other features, the instructions include configuring the machine learning model with the adjusted hyperparameters. In other features, the instructions include providing the training data set as inputs to the machine learning model configured with the adjusted hyperparameters to determine updated performance metrics. In other features, the instructions include determining whether the updated performance metrics are more optimal than the baseline performance metrics.

In other features, the instructions include saving the adjusted hyperparameters as the baseline hyperparameters in response to determining that the updated performance metrics are more optimal than the baseline performance metrics. In other features, the machine learning model is a light gradient-boosting machine (LightGBM) classifier model. In other features, the output variables include (i) standard treatment regimens and (ii) confidence levels for the standard treatment regimens. In other features, the input variables are stored on one or more storage devices. In other features, the machine learning model is configured to access the input variables via one or more networks.

A system includes memory hardware configured to store instructions and processing hardware configured to execute the instructions. The instructions include loading input variables, loading a first trained machine learning model, providing input variables to the first trained machine learning model to generate first output variables, determining whether the first output variables are above a threshold, loading a second trained machine learning model in response to determining that the first output variables are above the threshold, providing the input variables to the second trained machine learning model to generate second output variables in response to determining that the first output variables are above the threshold, loading a third trained machine learning model in response to determining that the first output variables are not above the threshold, and providing the input variables to the third trained machine learning model to generate third output variables in response to determining that the first output variables are not above the threshold.

In other features, the input variables include an identifier of an entity in a population, the output variables include a score for the entity indicated by the identifier, and the score indicates a likelihood of a feature of merit exceeding a threshold. In other features, the score is a value between zero and one hundred inclusive. In other features, the population includes entities that consume services and the feature of merit is a measure of service consumption. In other features, the population includes entities that coordinate services and the feature of merit is an amount of services. In other features, the input variables are generated by assigning alphanumeric strings to elements of a raw data set, tokenizing each alphanumeric string, converting the tokenized strings to scalar values, performing frequency filtering to emphasize scalar values based on a frequency the scalar values appear in a set of data objects while de-emphasizing scalar values based on a frequency the scalar values appear in a group of sets of data objects, and saving the filtered scalar values as input variables.

In other features, the first trained machine learning model is a light gradient-boosting machine (LightGBM) regressor model. In other features, the second trained machine learning model is a LightGBM regressor model. In other features, the third trained machine learning model is a LightGBM regressor model. In other features, the first output variables include a likelihood of a member switching a treatment regimen. In other features, the threshold is about 50%. In other features, the second output variables include at least one of (i) a likelihood of a member requiring at least one of (a) immunotherapy, (b) chemotherapy, and (c) hormonal therapy, (ii) a predicted future treatment regimen, (iii) probabilities of the member continuing on a current treatment regimen, (iv) probabilities of the member restarting a past treatment regimen, and (v) probabilities of the member discontinuing the current treatment regimen.

In other features, the third output variables include cost estimates for at least one of the predicted future treatment regimen, current treatment regimen, and past treatment regimen. In other features, the instructions include providing the first output variables to the second trained machine learning model to generate second output variables. In other features, the instructions include providing the second output variables to the third trained machine learning model to generate third output variables.

A system includes memory hardware configured to store instructions, and processing hardware configured to execute the instructions. The instructions include training a machine learning model by loading a training data set, the training data set including a first bin and a second bin, applying an under-sampling technique to elements of the first bin to generate an updated first bin, applying an over-sampling technique to elements of the second bin to generate an updated second bin, generating an updated training data set by merging the updated first bin and the updated second bin, and training the machine learning model with the updated training data set, and providing the input variables to the trained machine learning model to generate output variables.

The input variables are generated by assigning alphanumeric strings to elements of a raw data set, tokenizing each alphanumeric string, converting the tokenized strings to scalar values, performing frequency filtering to emphasize scalar values based on a frequency the scalar values appear in a set of data objects while de-emphasizing scalar values based on a frequency the scalar values appear in a group of sets of data objects, and saving the filtered scalar values as input variables. A subsequent set of input variables is generated subsequent to the input variables. The input variables and the subsequent set of input variables include episode identifiers. The input variables are archived to a database. The subsequent set of input variables are archived to the database in response to the episode identifiers of the subsequent set of input variables matching the episode identifiers of the input variables.

In other features, the instructions include automatically determining optimal hyperparameters for the trained machine learning model and configuring the trained machine learning model with the optimal hyperparameters. In other features, determining the optimal hyperparameters includes loading baseline hyperparameters, configuring the trained machine learning model with the baseline hyperparameters, running the configured machine learning model to determine baseline metrics, and saving the baseline hyperparameters as the optimal hyperparameters in response to the baseline metrics being above a threshold. In other features, determining the optimal hyperparameters includes, in response to the baseline metrics being at or below the threshold: adjusting the baseline hyperparameters, reconfiguring the trained machine learning model with the adjusted hyperparameters, and running the reconfigured machine learning model to determine updated metrics. Determining the optimal hyperparameters includes, in response to the updated metrics being more optimal than the baseline metrics, saving the updated metrics as the optimal hyperparameters.

In other features, the instructions include, in response to determining the output variables are above a threshold: loading a second trained machine learning model and providing the input variables to the second trained machine learning model to generate second output variables. In other features, the instructions include, in response to determining the output variables are not above the threshold: loading a third trained machine learning model and providing the input variables to the third trained machine learning model to generate third output variables. In other features, the trained machine learning model includes a light gradient-boosting machine model. In other features, the trained machine learning model includes a mixed effects random forests model with a light gradient-boosting machine regressor. In other features, input variables include a third bin and a fourth bin. In other features, the input variables of the third bin are assigned to fixed effects and the input variables of the fourth bin are assigned to mixed effects.

A system includes memory hardware configured to store instructions and processing hardware configured to execute the instructions. The instructions include loading a training data set, generating an updated training data set by applying an over-sampling technique and an under-sampling technique to the training data set, training a machine learning model using the updated training data set, loading baseline hyperparameters for the trained machine learning model, programmatically determining optimal hyperparameters for the trained machine learning model by testing a performance of the baseline hyperparameters, configuring the trained machine learning model with the determined hyperparameters, loading input variables, and providing the input variables to the configured trained machine learning model to generate output variables.

In other features, the input variables include an identifier of an entity in a population, the output variables include a score for the entity indicated by the identifier, and the score indicates a likelihood of a feature of merit exceeding a threshold. In other features, the instructions include generating a plurality of scores for a plurality of entities in the population and clustering the plurality of scores into a plurality of clusters. In other features, the plurality of clusters is three clusters. In other features, the plurality of clusters includes a particular cluster associated with a greatest risk. The instructions include adapting a graphical user interface in response to the score being assigned to the particular cluster.

In other features, the score is a value between zero and one hundred inclusive. In other features, the population includes entities that consume services and the feature of merit is a measure of service consumption of the entity. In other features, the population includes entities that coordinate services and the feature of merit is an amount of services advised by the entity. In other features, generating the updated training set includes partitioning the training data set into a first bin and a second bin, applying the over-sampling technique to elements of the first bin to generate an updated first bin, and applying the under-sampling technique to elements of the second bin to generate the updated second bin.

In other features, generating the updated training set includes merging the updated first bin and the updated second bin to generate a merged data structure and saving the merged data structure as the updated training set.

In other features, automatically determining optimal hyperparameters includes configuring the trained machine learning model with the baseline hyperparameters and running the trained machine learning model configured with the baseline hyperparameters to generate baseline metrics. In other features, automatically determining optimal hyperparameters includes parsing the baseline metrics to determine whether the baseline metrics are above a threshold and saving the baseline hyperparameters as the optimal hyperparameters in response to determining that the baseline metrics are above the threshold. In other features, automatically determining optimal hyperparameters includes, in response to determining that the baseline metrics are not above the threshold, adjusting the hyperparameters.

In other features, automatically determining optimal hyperparameters includes configuring the training machine learning model with the adjusted hyperparameters and running the trained machine learning model configured with the adjusted hyperparameters to generate updated metrics. In other features, automatically determining the optimal hyperparameters includes parsing the updated metrics to determine whether the updated metrics are more optimal than the baseline metrics and saving the adjusted hyperparameters as the optimal hyperparameters in response to determining that the updated metrics are more optimal than the baseline metrics. In other features, the machine learning model is a mixed effects random forest (MERF) with a light gradient-boosting machine (LightGBM) regressor. In other features, the output variables include at least one of (i) cost estimations for treatment groups and (ii) cost estimations for treatments.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4A is a functional block diagram of an example machine learning model transformation system.

FIG. 4B is a block diagram showing example data structures that may be stored in data stores of a machine learning model transformation system.

FIG. 5 is a flowchart of an example process for automatically generating input variables for machine learning models.

FIG. 6 is a flowchart of an example process for automatically generating input variables suitable for machine learning models.

FIG. 7 is a flowchart of an example process for automatically generating input variables suitable for machine learning models.

FIG. 8 is a flowchart of an example process for synthetically augmenting input variables and training machine learning models with the synthetically augmented input variables.

FIG. 9 is a flowchart of an example process for automatically optimizing hyperparameters for machine learning models.

FIG. 10 is a flowchart of an example process for executing trained machine learning models to generate output variables.

FIG. 11 is a flowchart of an example process for executing trained machine learning models to generate output variables.

FIG. 12 is a flowchart of processing input variables and executing trained machine learning models using the processed input variables to generate output variables.

In the drawings, reference numbers may be reused to identify similar and/or identical elements.

### DETAILED DESCRIPTION

### High-Volume Pharmacy

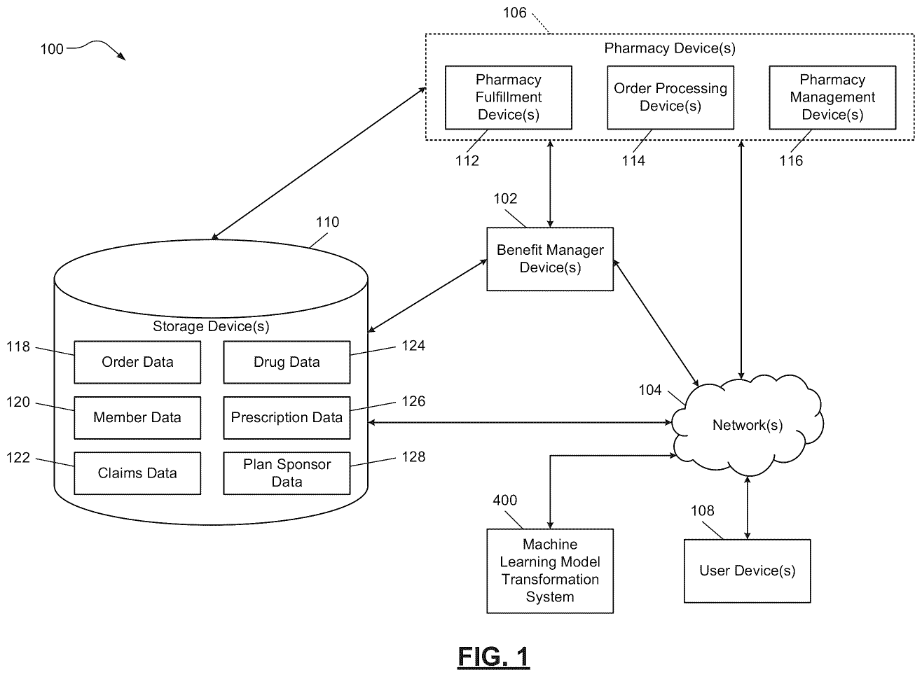

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However, in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

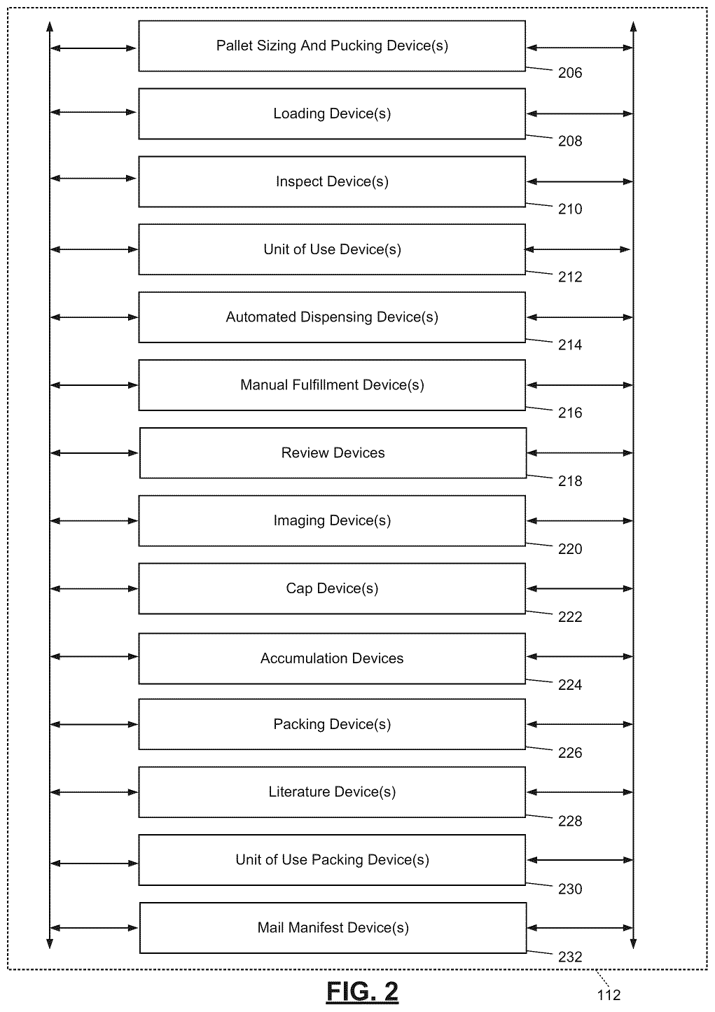

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

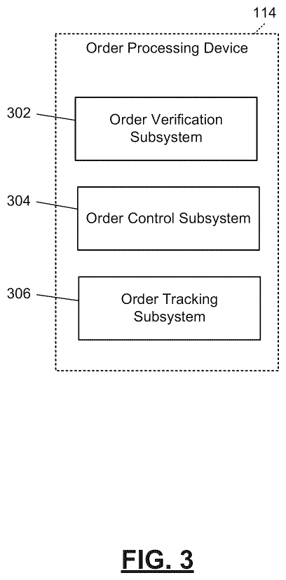

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Machine Learning Model Transformation System

Returning to FIG. 1, the system 100 may include a machine learning model transformation system—such as machine learning model transformation system 400—capable of automatically parsing and synthetically augmenting or adjusting training data sets and/or input variables in order to produce optimal results. By algorithmically parsing and improving training data sets and/or input variables, the machine learning model transformation system 400 obviates the need to apply brute force techniques during machine learning model training, thereby reducing the amount of computational resources required during training and execution while improving the overall speed and accuracy of the models.

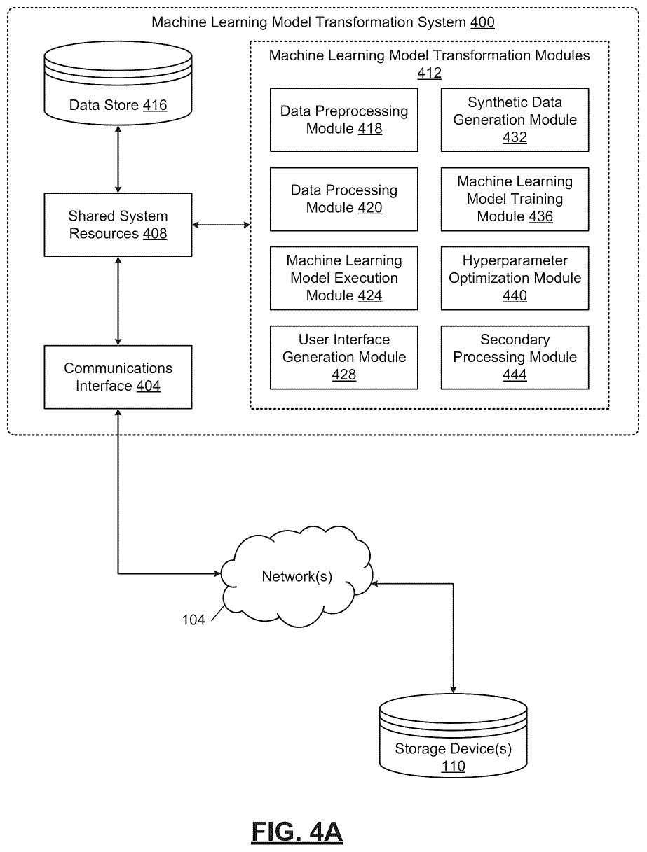

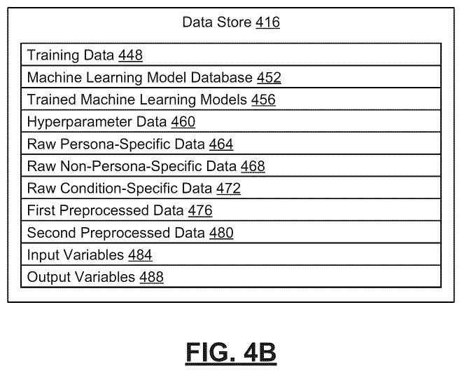

FIG. 4A is a functional block diagram of an example machine learning model transformation system 400. As shown in FIG. 4A, the machine learning model transformation system 400 may include a communications interface 404, shared system resources 408, one or more machine learning model transformation modules 412, and one or more data stores including non-transitory computer-readable storage media, such as data store 416. In various implementations, the communications interface 404 may be suitable for communicating with other components of the system 100 over the network 104. In various implementations, the communications interface 404 may include a transceiver suitable for sending and/or receiving data to and from other components of the system 100. In various implementations, the shared system resources 408 may include one or more processors, volatile and/or non-volatile computer memory—such as random-access memory, system storage—such as non-transitory computer-readable storage media, and one or more system buses connecting the components of the shared system resources 408.

In various implementations, the communications interface 404, the machine learning model transformation modules 412, and/or the data store 416 may be operatively coupled to the shared system resources 408 and/or operatively coupled to each other through the shared system resources 408. In various implementations, the machine learning model transformation modules 412 may be software modules stored on non-transitory computer-readable storage media, such as system storage and or the one or more data stores of the system 100. In various implementations, one or more processors of the shared system resources 408 may be configured to execute the instructions of the machine learning model transformation modules 412. In various implementations, the machine learning model transformation modules 412 may include a data preprocessing module 418, a data processing module 420, a machine learning model execution module 424, a user interface generation module 428, a synthetic data generation module 432, a machine learning model training module 436, a hyperparameter optimization module 440, and/or a secondary processing module 444.

In various implementations, the data preprocessing module 418 may be configured to process—such as by parsing, synthetically augmenting, and/or adjusting—raw data used to generate input variables. For example, the data preprocessing module 418 may be configured to improve the quality of the raw data used to generate input variables. In various implementations, the data processing module 420 may be configured to generate input variables and/or processing—such as by parsing, synthetically augmenting, and/or adjusting—input variables in order to improve their quality and/or suitability for use in machine learning applications. In various implementations, the machine learning model execution module 424 may be configured to load input variables, hyperparameters, and/or machine learning models, configure machine learning models with the loaded hyperparameters, and/or provide the loaded input variables to the machine learning models and execute the models to generate output variables. In various implementations, the user interface generation module 428 may be configured to generate interactive graphical user interfaces to allow a user to interact with the machine learning model transformation modules 412 and/or any of the data input to or generated by the modules.

In various implementations, the synthetic data generation module 432 may be configured to generate synthetic data for augmenting and/or enhancing data used to generate input variables and/or the input variables. In various implementations, the machine learning model training module 436 may be configured to train machine learning models using training data sets. In various implementations, the hyperparameter optimization module 440 may be configured to automatically select and/or optimize hyperparameters for machine learning models. In various implementations, the secondary processing module 444 may be configured to perform secondary processing operations on the outputs—such as output variables—of machine learning models. More detailed functionality and programming of the machine learning model transformation modules 412 will be described later on with reference to detailed drawings and/or flowcharts showing programming algorithms.

FIG. 4B is a block diagram showing example data structures that may be stored in data stores—such as data store 416—of the machine learning model transformation system 400. In various implementations, the data store 416 may include training data 448, a machine learning model database 452, trained machine learning models 456, hyperparameter data 460, raw persona-specific data 464, raw non-persona-specific data 468, raw condition-specific data 472, first preprocessed data 476, second preprocessed data 480, input variables 484, and/or output variables 488. In various implementations, training data 448 may include data structures related to data sets used for training machine learning models. In various implementations, machine learning model databases 452 may include data structures related to machine learning models—such as machine learning models with default parameters.

In various implementations, trained machine learning models 456 may include data structures related to machine learning models that have been trained by the machine learning model transformation system 400—such as machine learning models with saved parameters. In various implementations, hyperparameter data 460 may include data structures related to hyperparameter data for machine learning models—such as machine learning models of machine learning model database 452 and/or trained machine learning models 456. In various implementations, raw persona-specific data 464 may include data structures related to one or more personas. A persona may include data from one or more sources related to one or more specific users, such as users of the system 100. In various implementations, raw persona-specific data 464 may be loaded from storage device(s) 110.

In various implementations, raw non-persona-specific data 468 may include data structures related to one or more groups or populations, and/or data not related to individuals—such as data related to treatment regimens and/or drugs. In various implementations, raw non-persona-specific data 468 may be loaded from storage device(s) 110. In various implementations, raw condition-specific data 472 may include data structures related to one or more medical conditions and/or fields—such as cancer and/or oncology. In various implementations, raw condition-specific data 472 may be loaded from storage device(s) 110.

In various implementations, first preprocessed data 476 may include data processed by the data preprocessing module 418 that is suitable for generating input variables for machine learning models. In various implementations, second preprocessed data 480 may include data processed by the data preprocessing module 418 that is suitable for generating input variables for machine learning models. In various implementations, input variables 484 may include data structures related to input variables for machine learning models. For example, input variables 484 may include any combination of data structures described in Table 1 below:

TABLE 1
Unique patient identifier
Unique authorization identifier
Authorization request date
Cancer type
Current Procedural Terminology (CPT) code
Healthcare Common Procedure Coding System (HCPCS) code
Cancer regimen details
Cancer regimen group details
Insurance carrier
Preferred regimen
Age (excluding null records)
Weight in pounds (excluding null records)
Height in inches (excluding null records)
Authorization status (e.g., approved, denied, etc.)
Centers for Medicare & Medicaid Services (CMS) Place of Service Codes
ZIP Code for patient
Difference in years between date of birth and episode date
Physician ZIP Code
Physician National Provider Identifier (NPI)
Health plan costs
Pharmacy benefits
Social determinants of health (SDOH) data
Census data
National Cancer Institute (NCI) data
Surveillance, Epidemiology, and End Results (SEER) Program data
HCPCS CanMED data
Drugs approved for conditions related to cancer
Patient risk score
Provider risk score
Current cancer stage data
Estrogen receptor (ER) hormone status
HER2 receptor status
PD-L1 expression status
Progesterone receptor (PR) status
BRAF hormone receptor status
BRCA hormone receptor status
Requested regimen (excluding null records)
Treatment time
Tumor histology
Oncotype DX test results (N/A for null records)
Tumor pathology information
Prior chemotherapy treatment (N/A for null records)
Performance status (N/A for null records)
Progression or recurrency indicator (N/A for null records)
Recurrence indicator
Risk status
Tumor status
Treatment type
Tumor type
Treatment category
Reason for revision of systemic therapy
Tumor information
Estimated glomerular filtration rate (eGFR) status
Anaplastic lymphoma kinase (ALK) rearrangement status
KRAS gene status
Cisplatin indicators
Subtype of tumor
Previous treatment indicator
Presence of concurrent radiation therapy

In various implementations, output variables 488 may include data structures related to output variables from machine learning models. The data structures of data store 416 will be described in further detail later on with reference to detailed drawings and/or flowcharts showing programming algorithms.

### Flowcharts

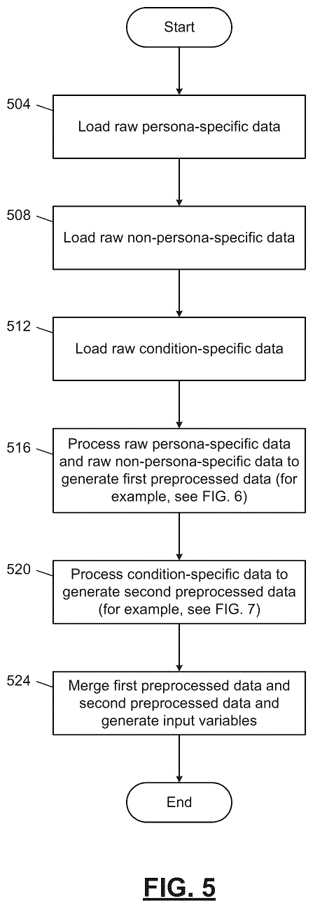

FIG. 5 is a flowchart of an example process for automatically generating input variables for machine learning models. Control begins at 504. At 504, the data preprocessing module 418 loads raw persona-specific data. For example, the data preprocessing module 418 may load raw persona-specific data from raw persona-specific data 464. In various implementations, raw persona-specific data 464 may include (i) demographic data of members, (ii) plan data of members, and/or (iii) authorization data of members. Control proceeds to 508. At 508, the data preprocessing module 418 loads raw non-persona-specific data. For example, the data preprocessing module 418 may load raw non-persona-specific data from raw non-persona-specific data 468. In various implementations, raw non-persona-specific data 468 may include (i) drug data, (ii) social determinants of health (SDOH) data, (iii) census data, (iv) geographical data, (v) National Cancer Institute (NCI) data—including Surveillance Epidemiology, and End Results (SEER) data, and/or (vi) CanMED data. Control proceeds to 512.

At 512, the data preprocessing module 418 may load raw condition-specific data. For example, the data preprocessing module 418 may load raw condition-specific data from raw condition-specific data 472. In various implementations, raw condition-specific data 472 may include data specific to a disease, such as cancer. In various implementations, raw condition-specific data 472 may include (i) medical oncology data, (ii) chemotherapy classification data, and/or (iii) consolidated regimen data. In various implementations, loaded data from raw condition-specific data 472 may include data objects having date tags within a threshold period of time of an authorization—such as ±180 days. Control proceeds to 516.

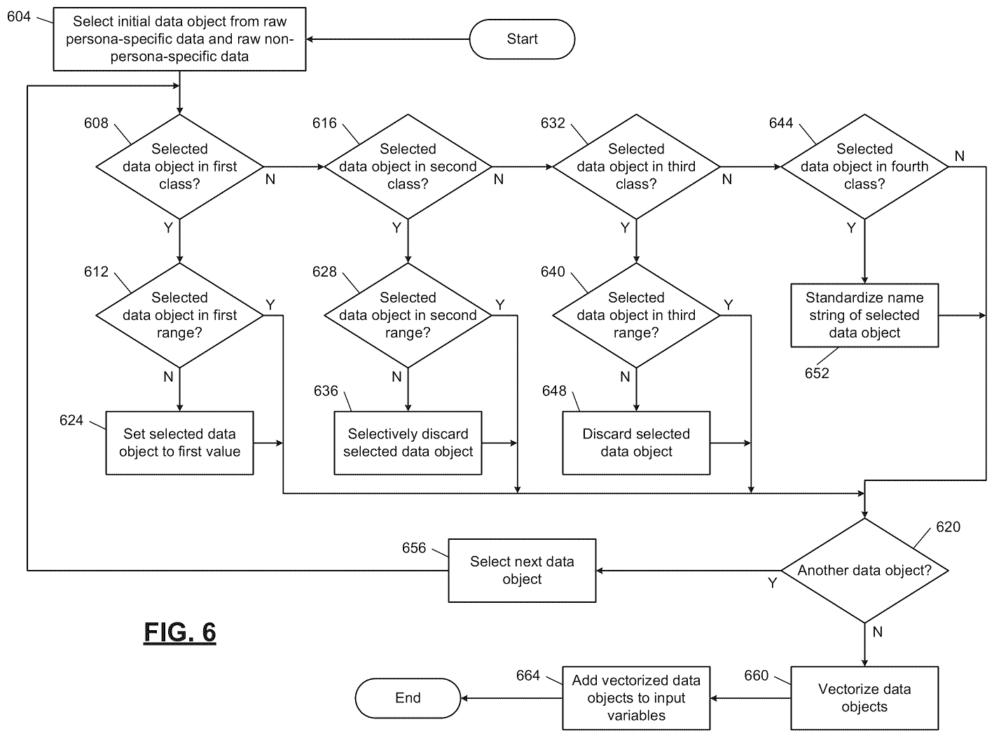

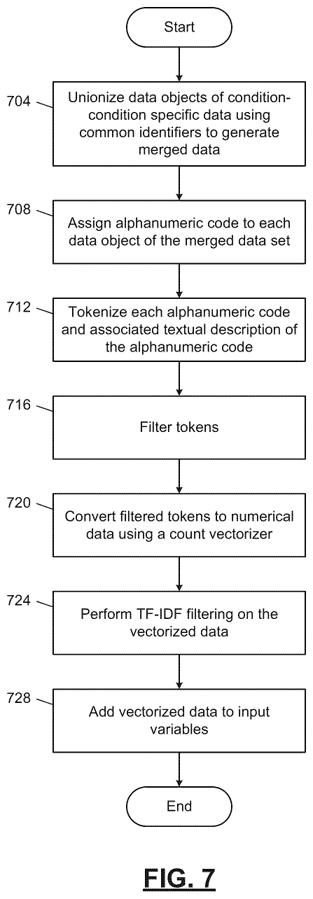

At 516, the data preprocessing module 418 and/or the data processing module 420 processes raw persona-specific data and raw non-persona-specific data to generate first preprocessed data. In various implementations, the first preprocessed data may be saved to first preprocessed data 476. Additional details of generating first preprocessed data will be described later on with reference to FIG. 6. Control proceeds to 520. At 520, the data preprocessing module 418 and/or the data processing module 420 processes condition-specific data to generate second preprocessed data. In various implementations, the second preprocessed data may be saved to second preprocessed data 480. Additional details of generating second preprocessed data will be described later on with reference to FIG. 7. Control proceeds to 524. At 524, the data processing module 420 merges the first preprocessed data and the second preprocessed data and generates input variables. In various implementations, the input variables may be saved to input variables 484.

FIG. 6 is a flowchart of an example process for automatically generating input variables suitable for machine learning models. Control begins at 604. At 604, the data preprocessing module 418 selects an initial data object from raw-persona specific data—such as the data objects loaded at 504—and raw non-persona-specific data—such as the data objects loaded at 508. Control proceeds to 608. At 608, the data preprocessing module 418 determines whether the selected data objects belongs to a first class. In various implementations, the first class may be a weight of a member. If at 608 the answer is yes, control proceeds to 612. Otherwise, control proceeds to 616. At 612, the data preprocessing module 418 determines whether the selected data object is within a first range. In various implementations, the first range may be between about 5 pounds and about 500 pounds. If at 612 the answer is yes, control proceeds to 620. Otherwise, control proceeds to 624. At 624, the data preprocessing module 418 sets the selected data object to a first value. In various implementations, the first value may be about 173 pounds. In various implementations, the first value may be about 183 pounds. Control proceeds to 620.

At 616, the data preprocessing module 418 determines whether the selected data object belongs to a second class. In various implementations, the second class may be cancer treatment regimens. If at 616 the answer is yes, control proceeds to 628. Otherwise, control proceeds to 632. At 628, the data preprocessing module 418 determines whether the selected data object is within a second range. In various implementations, the second range may be a range of costs up to and including about $250,000. If at 628 the answer is yes, control proceeds to 620. Otherwise, control proceeds to 636. At 636, the data preprocessing module 418 selectively discards the selected data object. In various implementations, the data preprocessing module 418 may discard the selected data object if the number of episodes per cancer associated with the treatment regimen is below about ten. In various implementations, the data preprocessing module 418 may discard the selected data object if the number of episodes per treatment regimen associated with the treatment regimen is below about five. Control proceeds to 620.

At 632, the data preprocessing module 418 determines whether the selected data object belongs to a third class. In various implementations, the third class may be costs associated with cancer episodes. If at 632 the answer is yes, control proceeds to 640. Otherwise, control proceeds to 644. At 640, the data preprocessing module 418 determines whether the selected data object is within a third range. In various implementations, the third range includes costs up to and including about the 95th percentile. If at 640 the answer is yes, control proceeds to 620. Otherwise, control proceeds to 648. At 648, the data preprocessing module 418 discards the selected data object. Control proceeds to 620.

At 644, the data preprocessing module 418 determines whether the selected data object belongs to a fourth class. In various implementations, the fourth class may be data related to drugs. If at 644 the answer is yes, control proceeds to 652. Otherwise, control proceeds to 620. At 652, the data preprocessing module 418 standardizes a name string associated with the selected data object. For example, the name string associated with the selected data object may include a non-standard description of a drug. The data preprocessing module 418 parses the non-standard description and assigns a standard description to the name string. Control proceeds to 620. At 620, the data preprocessing module 418 determines whether another data object that has not yet been processed is present in the loaded raw persona-specific data and loaded raw non-persona-specific data. If the answer is yes, control proceeds to 656. Otherwise, control proceeds to 660.

At 656, the data preprocessing module 418 selects the next data object that has not been processed. Control proceeds back to 608. At 660, the data preprocessing module 418 passes the processed persona-specific data and the processed non-persona specific data to the data processing module 420. The data processing module 420 vectorizes the data objects of the processed persona-specific data and the processed non-persona specific data. Control proceeds to 664. At 664, the data processing module 420 saves the vectorized data objects as input variables. For example, the data processing module 420 may save the vectorized data objects to input variables 484.

FIG. 7 is a flowchart of an example process for automatically generating input variables suitable for machine learning models. Control begins at 704. At 704, the data preprocessing module 418 unionizes data objects of condition specific data—such as the data objects loaded at 512—using common identifiers to generate merged data. Control proceeds to 708. At 708, the data preprocessing module 418 assigns an alphanumeric code to each data object of the merged data set. In various implementations, the alphanumeric codes may include Healthcare Common Procedure Coding System (HCPCS) codes that represent medical procedures, supplies, products, and services. Control proceeds to 712. At 712, the data preprocessing module 418 tokenizes each alphanumeric code and/or an associated textual description of the alphanumeric code. Control proceeds to 716. At 716, the data preprocessing module 418 filters the tokens generated at 712. Control proceeds to 720. At 720, the data preprocessing module 418 and/or the data processing module 420 converts each filtered token to numerical data. In various implementations, the data preprocessing module 418 and/or the data processing module 420 may use a count vectorizer to covert the filtered tokens to numerical values. Control proceeds to 724.

At 724, the data preprocessing module 418 and/or the data processing module 420 performs term frequency-inverse document frequency (TF-IDF) filtering on the vectorized data generated at 720. By performing TF-IDF filtering, values of fields increase proportionally to the number of times the value appears in a specific data object—such as a specific vector, but is offset by the number of times the code appears in a group of data objects—such as a group of vectors. This process amplifies vectors representing elements of the condition-specific data that are relevant while reducing the reducing the representation of elements that are generally relevant. As a result, specifically relevant elements of the condition-specific data may be amplified while generally relevant elements are not as amplified and/or de-amplified. Control proceeds to 728. At 728, the data preprocessing module 418 and/or the data processing module 420 adds the vectorized data to input variables, such as input variables 484.

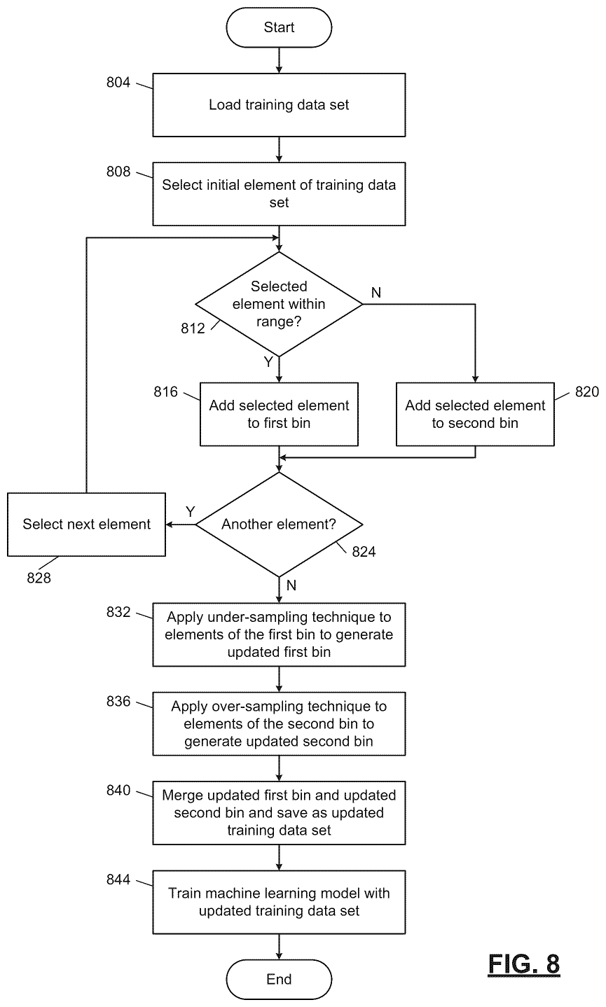

FIG. 8 is a flowchart of an example process for synthetically augmenting input variables and training machine learning models with the synthetically augmented input variables. Control begins at 804. At 804, the synthetic data generation module 432 loads a training data set—such as from training data 448. Control proceeds to 808. At 808, the synthetic data generation module 432 selects an initial element of the training data set. Control proceeds to 812. At 812, the synthetic data generation module 432 determines whether the selected element is within a range. In various implementations, the range may indicate a cost of treatment for a condition—such as cancer. In various implementations, the range may be defined by an upper bound and a lower bound. In various implementations, if a value of the selected element is at or below the upper bound and at or above the lower bound, the selected element may be considered to be within the range. In various implementations, if the value of the selected element is above the upper bound or below the lower bound, the selected element may be considered to be not within the range. If at 812 the selected element is within the range, control proceeds to 816. Otherwise, if at 812 the selected element is not within the range, control proceeds to 820.

At 816, the synthetic data generation module 432 adds the selected element to a first bin. Control proceeds to 824. At 820, the synthetic data generation module 432 adds the selected element to a second bin. Control proceeds to 824. At 824, the synthetic data generation module 432 determines whether another element is present in the training data set that has not yet been processed. If at 824 the answer is yes, control proceeds to 828. Otherwise, control proceeds to 832. At 824, the synthetic data generation module 432 selects the next element from the training data set and proceeds back to 812. At 832, the synthetic data generation module 432 applies an under-sampling technique to elements of the first bin to generate an updated first bin. In various implementations, the under-sampling technique may be a random under-sampling technique. Control proceeds to 836.

At 836, the synthetic data generation module 432 applies an over-sampling technique to elements of the second bin to generate an updated second bin. In various implementations, the over-sampling technique may be a synthetic minority over-sampling technique. In various implementations, the over-sampling technique may include the introduction of Gaussian noise. Control proceeds to 840. At 840, the synthetic data generation module 432 merges the updated first bin and the updated second bin and saves the merged bins as an updated training data set. For example, the synthetic data generation module 432 may save the updated training data set to training data 448. Control proceeds to 844.

At 844, the machine learning model training module 436 may train a machine learning model—such as a machine learning model from the machine learning model database 452—with the updated training data set. In various implementations, the machine learning model training module 436 may retrain a trained machine learning model—such as from trained machine learning models 456—with the updated training data set.

In various implementations, the training data set may include the first bin, the second bin, and a baseline bin. The baseline bin may include unadjusted training data. The machine learning model may be configured with training data from the baseline bin and run to determine baseline metrics. In response to the baseline metrics being above a threshold, baseline sampling of the baseline bin and the baseline data may be saved as a hybrid dataset.

In various implementations, the results of the process may be applied to future datasets. In various implementations, the results of the process may be used to validate the process of the algorithm's training and adjust or optimize the machine learning model. In various implementations, over-sampling and/or under-sampling techniques may be dynamically updated for improved results.

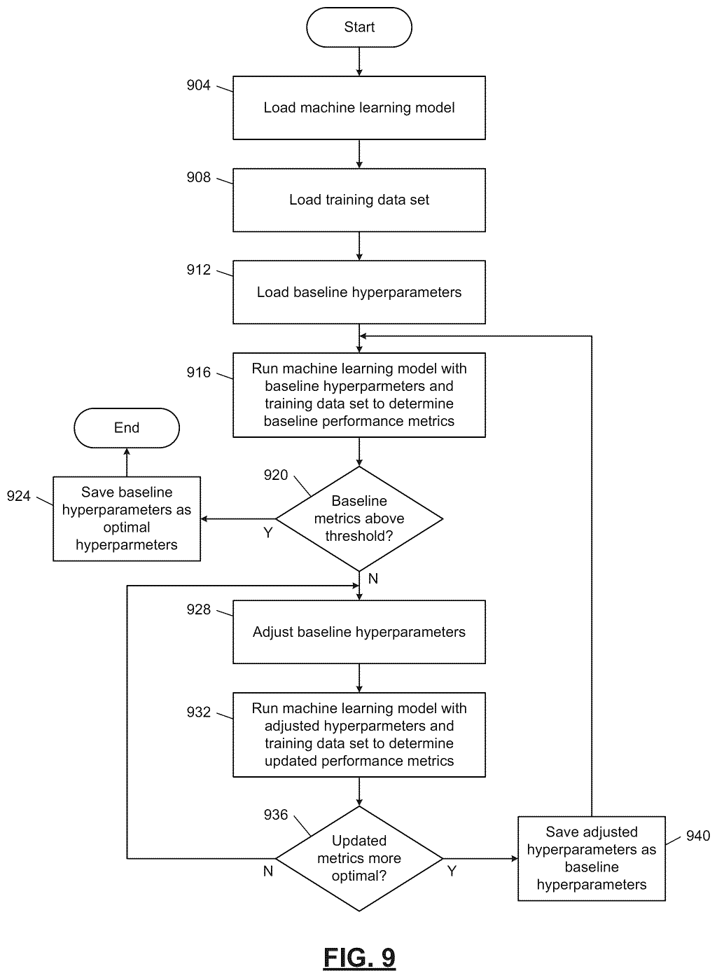

FIG. 9 is a flowchart of an example process for automatically optimizing hyperparameters for machine learning models. Control begins at 904. At 904, the hyperparameter optimization module 440 loads a machine learning model—such as from the machine learning model database 452 or trained machine learning models 456. Control proceeds to 908. At 908, the hyperparameter optimization module 440 loads a training data set—such as from training data 448. Control proceeds to 912. At 912, the hyperparameter optimization module 440 loads baseline hyperparameters for the loaded machine learning model—such as from hyperparameter data 460. Control proceeds to 916. At 916, the hyperparameter optimization module 440 may call on the machine learning execution module 424 to configure the loaded machine learning model with the baseline hyperparameters and execute the configured machine learning model with the training data as input variables to determine baseline performance metrics. Control proceeds to 920.

At 920, the hyperparameter optimization module 440 determines whether the baseline performance metrics are above a threshold. If at 920 the answer is yes, control proceeds to 924. Otherwise, control proceeds to 928. At 928, the hyperparameter optimization module 440 adjusts the baseline hyperparameters. Control proceeds to 932. At 932, the hyperparameter optimization module 440 may call on the machine learning execution module 424 to reconfigure the loaded machine learning model with the adjusted hyperparameters and execute the reconfigured machine learning model with the training data as input variables to determine updated performance metrics. Control proceeds to 936. At 936, the hyperparameter optimization module 440 determines whether the updated performance metrics are more optimal than the baseline performance metrics. If at 936 the answer is yes, control proceeds to 940. Otherwise, control proceeds back to 928. At 940, the hyperparameter optimization module 440 saves the adjusted hyperparameters as the baseline hyperparameters and proceeds back to 916.

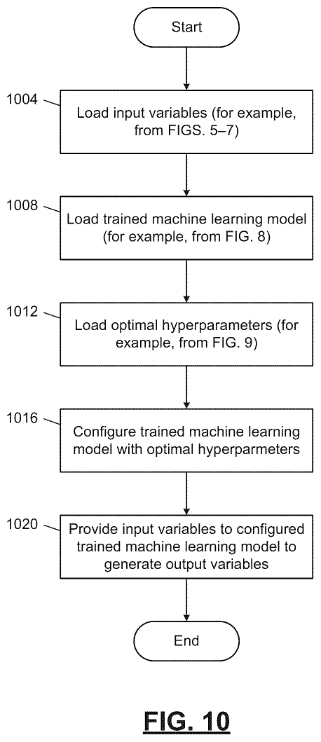

FIG. 10 is a flowchart of an example process for executing trained machine learning models to generate output variables. Control begins at 1004. At 1004, the machine learning model execution module 424 loads input variables. In various implementations, the machine learning model execution module 424 loads input variables from input variables 484. In various implementations, the input variables may be generated according to techniques previously described with reference to FIGS. 5-7. Control proceeds to 1008. At 1008, the machine learning model execution module 424 loads a trained machine learning model. In various implementations, the trained machine learning model may be loaded from trained machine learning models 456. In various implementations, the machine learning model may be trained according to techniques previously described with reference to FIG. 8. Control proceeds to 1012.

At 1012, the machine learning model execution module 424 may load optimal hyperparameters for the machine learning model loaded at 1008. In various implementations, the optimal hyperparameters may be loaded from hyperparameter data 460. In various implementations, the optimal hyperparameters may be determined according to techniques previously described with reference to FIG. 9. Control proceeds to 1016. At 1016, the machine learning model execution module 424 configures the trained machine learning model with the optimal hyperparameters. For example, the machine learning model execution module 424 may configure the trained machine learning model loaded at 1008 with the optimal hyperparameters loaded at 1012. Control proceeds to 1020. At 1020, the machine learning model execution module 424 may provide the input variables to the configured trained machine learning model to generate output variables. In various implementations, the machine learning model execution module 424 may provide input variables loaded at 1004 to the machine learning model configured at 1016 to generate output variables. In various implementations, output variables may be saved to output variables 488.

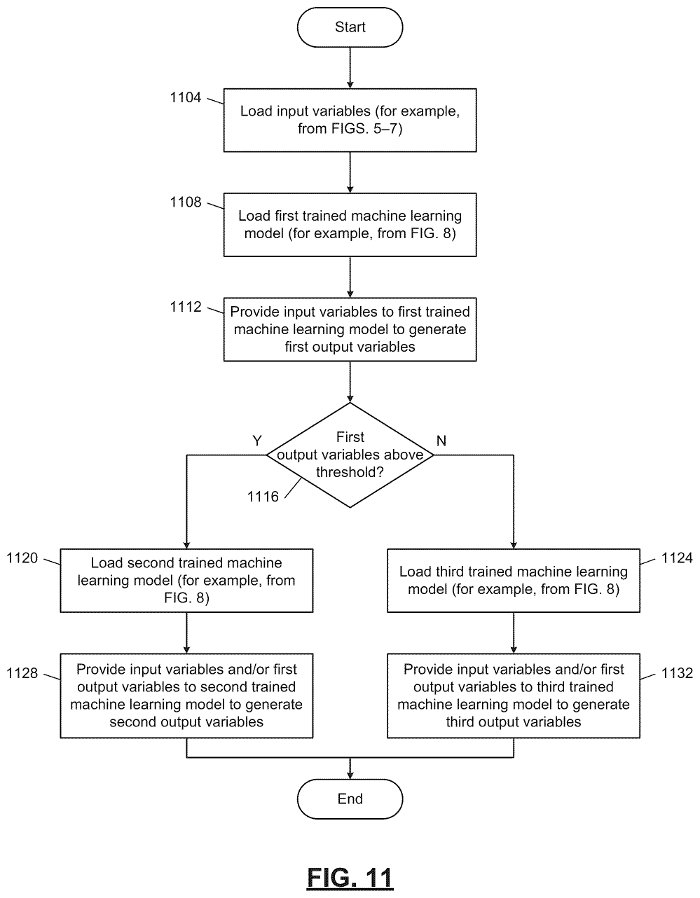

FIG. 11 is a flowchart of an example process for executing trained machine learning models to generate output variables. Control begins at 1104. At 1104, the machine learning model execution module 424 loads input variables. In various implementations, the machine learning model execution module 424 loads input variables from input variables 484. In various implementations, the input variables may be generated according to techniques previously described with reference to FIGS. 5-7. Control proceeds to 1108. At 1108, the machine learning model execution module 424 loads a first trained machine learning model. In various implementations, the first trained machine learning model may be loaded from trained machine learning models 456. In various implementations, the first trained machine learning model may be trained according to techniques previously described with reference to FIG. 8. Control proceeds to 1112.

At 1112, the machine learning model execution module 424 provides the input variables loaded at 1104 to the first trained machine learning model loaded at 1108 to generate first output variables. In various implementations, the first output variables may be saved to output variables 488. Control proceeds to 1116. At 1116, the machine learning model execution module 424 determines whether the first output variables are above a threshold. In various implementations, if the first output variables indicate a probability of a user or a member switching a treatment regimen, the threshold may be about 0.5 or 50%. If at 1116 the machine learning model execution module 424 determines that the first output variables are above the threshold, control proceeds to 1120. Otherwise, control proceeds to 1124.

At 1120, the machine learning model execution module 424 loads a second trained machine learning model. In various implementations, the machine learning model execution module 424 loads the second trained machine learning model from trained machine learning models 456. In various implementations, the second trained machine learning model may be trained according to techniques previously described with reference to FIG. 8. Control proceeds to 1128. At 1128, the machine learning model execution module 424 provides input variables—such as input variables loaded at 1104—and/or first output variables—such as first output variables generated at 1112—to the second trained machine learning model to generate second output variables. In various implementations, the second output variables may be saved to output variables 488.

At 1124, the machine learning model execution module 424 loads a third trained machine learning model. In various implementations, the machine learning model execution module 424 loads the third trained machine learning model from trained machine learning models 456. In various implementations, the third trained machine learning model may be trained according to techniques previously described with reference to FIG. 8. Control proceeds to 1132. At 1132, the machine learning model execution module 424 provides input variables—such as input variables loaded at 1104—and/or first output variables—such as first output variables generated at 1112—to the third trained machine learning model to generate third output variables. In various implementations, the third output variables may be saved to output variables 488.

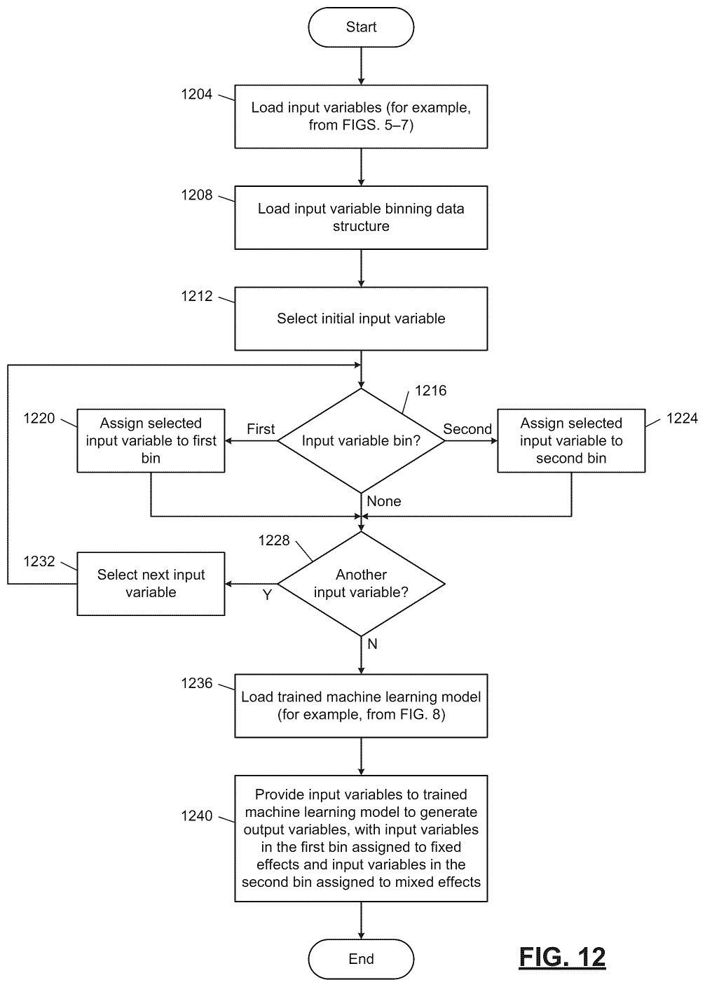

FIG. 12 is a flowchart of processing input variables and executing trained machine learning models using the processed input variables to generate output variables. Control begins at 1204. At 1204, the machine learning model execution module 424 loads input variables. In various implementations, the input variables may be loaded from input variables 484. In various implementations, the input variables may be generated according to techniques previously described with reference to FIGS. 5-7. Control proceeds to 1208. At 1208, the machine learning model execution module 424 loads an input variable binning data structure. In various implementations, the input variable binning data structure may include information on whether input variables belong to a first bin or a second bin. In various implementations, the input variable binning data structure may be loaded from input variables 484. Control proceeds to 1212. At 1212, the machine learning model execution module 424 selects an initial input variable from input variables loaded at 1204. Control proceeds to 1216.

At 1216, the machine learning model execution module 424 parses the input variable binning data structure loaded at 1208 and the selected input variable and determines whether the selected input variable belongs to the first bin, the second bin, or neither bin. If at 1220 the machine learning execution module 424 determines that the selected input variable belongs to the first bin, control proceeds to 1220, where the machine learning execution module 424 assigns the selected input variable to the first bin. Control proceeds to 1228. If at 1220 the machine learning execution module 424 determines that the selected input variable belongs to the second bin, control proceeds to 1224, where the machine learning execution module 424 assigns the selected input variable to the second bin. Control proceeds to 1228. If at 1216 the machine learning execution module 424 determines that the selected input variable does not belong to either bin, control proceeds to 1228.

At 1228, the machine learning model execution module 424 determines whether there is another loaded input variable that has not yet been processed. If yes, control proceeds to 1232. Otherwise, control proceeds to 1236. At 1232, the machine learning model execution module 424 selects the next input variable and proceeds back to 1216. At 1236, the machine learning model execution module 424 loads a trained machine learning model. In various implementations, the trained machine learning model may be loaded from trained machine learning models 456. In various implementations, the trained machine learning model may include a mixed effects random forest (MERF) model with a light gradient-boosting machine (LightGBM) as the regressor. Control proceeds to 1240. At 1230, the machine learning model execution module 424 assigns input variables in the first bin to fixed effects and input variables in the second bin to mixed effects. The machine learning model execution module 424 provides the input variables to the trained machine learning model loaded at 1236 and generates output variables. In various implementations, the output variables may be saved to output variables 488.

### Estimating Patient-Level Risk Scores

In various implementations, the machine learning model transformation system 400 may be configured to estimate patient-level risk scores. Patient-level risk scores may be a numerical value—such as a scalar value in a range of about 0 to about 100—indicating an estimated risk of a patient having a high-risk cancer episode or requiring high-cost treatment. For example, at 1004, the machine learning model transformation system 400 may load any of the input variables previously described with respect to Table 1. In various implementations, the machine learning model transformation system 400 may also load any of the input variables described below in Table 2:

TABLE 2
Diagnosis code
Clinical classification code
Provider specialty taxonomy
Address for all episode authorizations
Names for all episode authorizations
Regimen group count calculated at patient level
Regimen group count calculated at cancer level
Numeric scores for metric risk from oncology unionized data
Fall febrile neutropenia (FN) risk
Prescription benefit status
Physician count aggregated at the patient level
Place of service
Patient identification, patient state, and cancer stratified to a group level

In various implementations, a light gradient-boosting machine (LightGBM) regressor model may be selected and loaded at 1008. In various implementations, the output variables generated at 1020 may include (i) a per-patient risk score (e.g., 0-100) indicating a risk of a patient having a high-risk episode or a high-cost treatment, (ii) a patient identifier, (iii) a physician identifier, (iv) a physician state, and/or (v) a patient state. In various implementations, the output variables may be fed into a database—such as a database stored in storage device(s) 110 and/or data store 416—and accessed by a user interface generated by the user interface generation module 428.

### Estimating Provider-Level Risk Score

In various implementations, the machine learning model transformation system 400 may be configured to estimate provider-level risk scores. In various implementations, the provider-level risk score may be a per-provider score—such as a scalar value in a range of about 0 to about 100. In various implementations, at 1004, any of the input variables from Table 1 may be loaded. In various implementations, input variables from Table 3 below may be loaded:

TABLE 3

Cancer type
Place of service
Prescription benefit
Gender
Current stage of cancer
Treatment timeline
ER hormone receptor status
HER2 status
Metastatic cancer status
Cancer status
BRAF hormone status
PD-L1 expression status
PR hormone status
KRAS status
Location information
Cisplatin chemotherapy status
Diagnosis data
Disease data
Tumor histology data
Node data
Oncotype DX test results
Pathology data
Previous chemotherapy data
Progression or recurrence data
Performance status
Recurrence data
Risk status
Cancer stage at diagnosis
Tumor status
Treatment type
Tumor type
Treatment category
Reason for revision of systemic therapy
Tumor information
Cancer stage data
Regimen group
Regimen abbreviation
Procedure abbreviation

In various implementations, episode level data may be used. In various implementations, count vectorization may be used on the procedure codes in the episode. In various implementations, separate data frames may be used for custom and standard regimens. In various implementations, separate data frames may be used for impact on physician risk scores. In various implementations, separate data frames for custom and standard regimens may be created. In various implementations, a target cost bucket variable may be created and grouped in (i) a $100,000-$250,000 category, (ii) a greater than $250,000 category, and/or (iii) a greater than $100,000 category.

In various implementations, a LightGBM regressor or a classifier model may be selected and loaded at 1008. In various implementations, the output variables at 1020 may include (i) a per-provider risk score (e.g., 0-100) and/or (ii) clusters for the per-provider risk scores (e.g., indicating high risk, medium risk, and/or low risk).

### Provider Cost at Point of Authorization

In various implementations, the machine learning model transformation system 400 may be configured to provide prospective cost estimates of courses of treatment over a window of time. In various implementations, at 1008, the machine learning model transformation system 400 may load a LightGBM regressor model. In various implementations, the output variables generated at 1020 may include one or more prospective cost estimates for one or more courses of treatments over a time window. In various implementations—such as for episodic calculations, the time window may be over the next sixth months following the calculations. In various implementations, the output variables may be fed into a database—such as a database stored in storage device(s) 110 and/or data store 416—and accessed by a user interface generated by the user interface generation module 428. In various implementations, after the output variables are generated and/or stored, the secondary processing module 444 may generate profiles for providers based on output variables.

In various implementations, the machine learning model transformation system 400 may be configured to incorporate PWPM spend predicting prospectively for comparison providers event for a future six months and/or a year-on-year comparison. In various implementations, output variables of the machine learning model transformation system 400 may include a total spend (e.g., total drug costs), member months for health insurance organizations, and/or total medical costs. In various implementations, the output variables may be stored in one or more databases, which may feed into visualization software such as Tableau, Power BI, and/or Python software.

### Prospective Cost Estimate for Treatment at Point of Authorization

In various implementations, the machine learning model transformation system 400 may be configured to provide prospective cost estimates for treatments at points of authorization—such as standard, non-standard, and/or supportive therapy treatments for any line of business a health plan may support.

In various implementations, at 1008, the machine learning model transformation system 400 may load a LightGBM regressor model. In various implementations, the output variables generated at 1020 may include prospective cost estimates for treatments at points of authorization. In various implementations, the output variables may be fed into a database—such as a database stored in storage device(s) 110 and/or data store 416—and accessed by a user interface generated by the user interface generation module 428. In various implementations, supportive therapy treatments may reflect treatments that do not fall within traditional chemotherapy codes. In various implementations, separate cost estimate models may be generated for non-standard (e.g., customized) treatment regimens and/or standard treatment regimens. In addition to a prospective (e.g., looking forward for the next six months) cost estimate, the machine learning model transformation system 400 may generate a lower-bound quantile estimate and/or an upper-bound quantile estimate.

### Standardization of Non-Standard Treatment Regimens

In various implementations, the machine learning model transformation system 400 may be configured to generate standard treatment regimens based on non-standard regimens—such as for any line of business a health plan may support. In various implementations, at 1004, the machine learning model transformation system 400 may be configured to load non-standard treatment regimens as input variables—in addition to or instead of any of the input variables previously described with reference to Table 1. In various implementations, the machine learning model transformation system 400 may load a LightGBM model at 1008—such as a LightGBM classifier model trained on standard regimens to test on non-standard (e.g., custom) regimens. In various implementations, the output variables generated at 1020 may include (i) standard treatment regimens and/or (ii) confidence levels for the standard treatment regimens.

### Identifying Patients Switching Cancer Treatment Regimens

In various implementations, the machine learning model transformation system 400 may be configured to identify patients switching cancer treatment regimens—such as for any line of business a health plan may support. In various implementations, at 1104, the machine learning model transformation system 400 may be configured to load (i) any of the input variables previously described with reference to Table 1, (ii) SEER drug classes that have been merged to authorizations using HCPCS, NDC, and/or CPT codes, and/or SEER supportive therapy drugs generated by text mining names. In various implementations a first classifier model may be loaded by the machine learning model transformation system 400 at 1108. In various implementations, output variables generated at 1112 may include a likelihood of a user, member, and/or patient switching therapies. In various implementations, a regression model—such as a LightGBM model may be loaded by the machine learning model transformation system 400 at 1120.

In various implementations, this may allow modeling of chemotherapy and/or supportive therapy episodes. In various implementations, supportive therapy may be identified by Part B equivalent and/or CPT code classifications.

In various implementations, the output variables generated at 1128 may include (i) a likelihood of the user, member, and/or patient needing: (a) immunotherapy, (b) chemotherapy, and/or (c) hormonal therapy, (ii) predicted future treatment regimens (e.g., probabilities of types of SEER systematic categorizations), (iii) probabilities of the user, member, and/or patient continuing on a regimen, (iv) probabilities of the user, member, and/or patient restarting a regimen, (v) probabilities of the user, member, and/or patient discontinuing a regimen, and/or (vi) cost estimates for the switched regimen. In various implementations, a second classifier model may be loaded by the machine learning model transformation system 400 at 1124. In various implementations, output variables generated at 1132 may include a cost estimate for the regimen.

### Differential Cost Estimations by Treatment Groups and Treatment Patterns for Standard and Non-Standard Regimens

In various implementations, the machine learning model transformation system 400 may be configured to provide differential cost estimations by treatment groups and treatment patterns—such as for any line of business a health plan may support. In various implementations, at 1204, the machine learning model transformation system 400 may load any of the input variables previously described with reference to Table 1. In various implementations, at 1204, the machine learning model transformation system 400 may load any of the input variables described below in Table 4:

TABLE 4

Age
Disease type
Authorizations (linked to claims)
Treatment group
Procedure codes
Treatment
Clinical features
Diagnosis features
Demographic features
Clinical health
Social determinants of health
Episode-level criteria
Previous diagnosis data

In various implementations, the binning data structure loaded at 1208 may indicate that (i) disease type, (ii) treatment group, and/or (iii) procedure codes belong to the first bin, while treatment belongs to the second bin. In various implementations, a mixed effects random forest (MERF) with LightGBM as the regressor may be loaded at 1236. In various implementations, hyperparameters for the machine learning model loaded at 1236 may be selected based on fixed and/or random effects. In various implementations, output variables generated at 1240 may include (i) cost estimation for treatment groups and/or (ii) cost estimation for treatments.

In various implementations, the machine learning model transformation system 400 may be used as treatment pathway optimizers, clinical decision support models for providers (such as by noting the impacts of their outcomes). In various implementations, the machine learning model transformation system 400 may be used within health plans for contract negotiation and/or management of account reserves.

### Archiving Models and Prediction Updates

In various implementations, previous predictions may be archived based on older prediction dates and refreshed monthly. If the same episode has been predicted in prior monthly refreshes and if the same episode cost has been predicted in the prior month (or within the past six months), the predictions may be archived. In various implementations, episode IDs may be equivalent to each other in order for the prediction to be archived. In various implementations, if episode IDs are not equivalent to each other, the new predictions may be appended to prior models. Maximum authorization dates may be selected for the latest prediction per episode ID (e.g., if there are two or more dates present of the same episode ID, the maximum value may be selected). This improves predictions with any update data lag and in length of model data features. Inference timelines may also be filtered to ensure claims and data lag.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
memory hardware configured to store instructions, and
processing hardware configured to execute the instructions, wherein the instructions include:
training a machine learning model by:
loading a training data set, the training data set including a first bin and a second bin,
applying an under-sampling technique to elements of the first bin to generate an updated first bin,
applying an over-sampling technique to elements of the second bin to generate an updated second bin,
generating an updated training data set by merging the updated first bin and the updated second bin, and
training the machine learning model with the updated training data set;
generating input variables by:
assigning alphanumeric strings to elements of a raw data set,
tokenizing each alphanumeric string,
converting the tokenized strings to scalar values,
performing frequency filtering to emphasize scalar values based on a frequency the scalar values appear in a set of data objects while de-emphasizing scalar values based on a frequency the scalar values appear in a group of sets of data objects,
saving the filtered scalar values as input variables, and
providing the input variables to the trained machine learning model to generate output variables,
wherein a subsequent set of input variables is generated subsequent to the input variables;
wherein the input variables and the subsequent set of input variables include episode identifiers;
wherein the input variables are archived to a database; and
wherein the subsequent set of input variables are archived to the database in response to the episode identifiers of the subsequent set of input variables matching the episode identifiers of the input variables.

2. The system of claim 1 wherein the instructions include:
automatically determining optimal hyperparameters for the trained machine learning model; and
configuring the trained machine learning model with the optimal hyperparameters.

3. The system of claim 2 wherein determining the optimal hyperparameters includes:
loading baseline hyperparameters;
configuring the trained machine learning model with the baseline hyperparameters;
running the configured machine learning model to determine baseline metrics; and
in response to the baseline metrics being above a threshold, saving the baseline hyperparameters as the optimal hyperparameters.

4. The system of claim 3 wherein determining the optimal hyperparameters includes, in response to the baseline metrics being at or below the threshold:
adjusting the baseline hyperparameters,
reconfiguring the trained machine learning model with the adjusted hyperparameters,
running the reconfigured machine learning model to determine updated metrics, and
in response to the updated metrics being more optimal than the baseline metrics, saving the updated metrics as the optimal hyperparameters.

5. The system of claim 1 wherein the instructions include, in response to determining the output variables are above a threshold:
loading a second trained machine learning model, and
providing the input variables to the second trained machine learning model to generate second output variables.

6. The system of claim 5 wherein the instructions include, in response to determining the output variables are not above the threshold:
loading a third trained machine learning model, and
providing the input variables to the third trained machine learning model to generate third output variables.

7. The system of claim 1 wherein the trained machine learning model includes a light gradient-boosting machine model.

8. The system of claim 1 wherein the trained machine learning model includes a mixed effects random forests model with a light gradient-boosting machine regressor.

9. The system of claim 8 wherein input variables include a third bin and a fourth bin.

10. The system of claim 9 wherein the input variables of the third bin are assigned to fixed effects and the input variables of the fourth bin are assigned to mixed effects.

11. A system comprising:
memory hardware configured to store instructions; and
processing hardware configured to execute the instructions, wherein the instructions include:
loading a training data set,
generating an updated training data set by applying an over-sampling technique and an under-sampling technique to the training data set,
training a machine learning model using the updated training data set,
loading baseline hyperparameters for the trained machine learning model,
programmatically determining optimal hyperparameters for the trained machine learning model by testing a performance of the baseline hyperparameters,
configuring the trained machine learning model with the determined hyperparameters,
loading input variables, and
providing the input variables to the configured trained machine learning model to generate output variables.

12. The system of claim 11 wherein:
the input variables include an identifier of an entity in a population;
the output variables include a score for the entity indicated by the identifier; and
the score indicates a likelihood of a feature of merit exceeding a threshold.

13. The system of claim 12 wherein the instructions include:
generating a plurality of scores for a plurality of entities in the population; and
clustering the plurality of scores into a plurality of clusters.

14. The system of claim 13 wherein the plurality of clusters is three clusters.

15. The system of claim 14, wherein:
the plurality of clusters includes a particular cluster associated with a greatest risk; and
the instructions include adapting a graphical user interface in response to the score being assigned to the particular cluster.

16. The system of claim 15 wherein the score is a value between zero and one hundred inclusive.

17. The system of claim 16 wherein:
the population includes entities that consume services; and
the feature of merit is a measure of service consumption of the entity.

18. The system of claim 17 wherein:
the population includes entities that coordinate services; and
the feature of merit is an amount of services advised by the entity.

19. The system of claim 11 wherein generating the updated training set includes:
partitioning the training data set into a first bin and a second bin;
applying the over-sampling technique to elements of the first bin to generate an updated first bin; and
applying the under-sampling technique to elements of the second bin to generate the updated second bin.

20. The system of claim 19 wherein generating the updated training set includes:
merging the updated first bin and the updated second bin to generate a merged data structure; and
saving the merged data structure as the updated training set.

21. The system of claim 20 wherein automatically determining optimal hyperparameters includes:
configuring the trained machine learning model with the baseline hyperparameters; and
running the trained machine learning model configured with the baseline hyperparameters to generate baseline metrics.

22. The system of claim 21 wherein automatically determining optimal hyperparameters includes:
parsing the baseline metrics to determine whether the baseline metrics are above a threshold; and
in response to determining that the baseline metrics are above the threshold, saving the baseline hyperparameters as the optimal hyperparameters.

23. The system of claim 22 wherein automatically determining optimal hyperparameters includes, in response to determining that the baseline metrics are not above the threshold, adjusting the hyperparameters.

24. The system of claim 23 wherein automatically determining optimal hyperparameters includes:
configuring the training machine learning model with the adjusted hyperparameters; and
running the trained machine learning model configured with the adjusted hyperparameters to generate updated metrics.

25. The system of claim 24 wherein automatically determining the optimal hyperparameters includes:
parsing the updated metrics to determine whether the updated metrics are more optimal than the baseline metrics; and
in response to determining that the updated metrics are more optimal than the baseline metrics, saving the adjusted hyperparameters as the optimal hyperparameters.

26. The system of claim 25 wherein the machine learning model is a mixed effects random forest (MERF) with a light gradient-boosting machine (LightGBM) regressor.

27. The system of claim 26 wherein the output variables include at least one of (i) cost estimations for treatment groups and (ii) cost estimations for treatments.
